(19) United States
(12) Patent Application Publication
(10) Pub. No.: US 2008/0184640 A1
(43) Pub. Date: Aug. 7, 2008

(54) MOVABLE BUILDING AND BUILDING FOUNDATION

(76) Inventors: James Rhodes, Las Vegas, NV (US); Matthew Priddy, Las Vegas, NV (US)

Correspondence Address: BELL, BOYD, & LLOYD LLP, P.O. BOX 1135, CHICAGO, IL, 60690, US

(21) Appl. No.: 11/689,348

(22) Filed: Mar. 21, 2007

Related U.S. Application Data
(60) Provisional application No. 60/887,696, filed on Feb. 1, 2007.

(51) Int. Cl. E02D 27/00

(52) U.S. Cl. 52/293.3; 52/294

(57) ABSTRACT

A building foundation includes a molded structure being formed from a first substance and a second substance formed within the molded structure. The second substance displaces a predetermined volume of the first substance and is lighter than the first substance. The building foundation also includes a device for coupling the molded structure to a movable building in a factory. The building foundation is further adapted to be transported to a building site.

### RELATED APPLICATIONS

This application is related to co-pending U.S. patent application Ser. Nos. 11/431,196 entitled “BUILDING TRANSPORT DEVICE” and filed on May 9, 2006; Ser. No. 11/620,103 entitled “DEVICE AND METHOD FOR TRANSPORTING A LOAD” and filed on Jan. 5, 2007; 11/559,229 entitled “TRANSPORT DEVICE CAPABLE OF ADJUSTMENT TO MAINTAIN LOAD PLANARITY” and filed on Nov. 13, 2006; Ser. No. 11/620,560 entitled “METHOD AND APPARATUS FOR MOBILE STEM WALL” and filed on Jan. 5, 2007; and U.S. Provisional Patent Application Ser. No. 60/887,696, entitled “METHOD AND APPARATUS FOR INTEGRATED INVENTORY AND PLANNING” and filed on Feb. 1, 2007 the entire contents of each of which is hereby incorporated by reference.

### BACKGROUND

One foundation technique frequently used in home building is to pour concrete directly on the building site to form a building foundation slab. A building foundation anchors a home firmly in the ground, working like roots to hold a house down and tie it into the ground below. Further, the building foundation often encompasses the entire footprint of house and thus provides support for all of the load bearing walls of the home. It should be noted, the building foundation can also provide support for any non-load bearing walls.

A building foundation is generally constructed in place at the home site. Typically, the building foundation is constructed of poured concrete (reinforced with steel rebar or un-reinforced). The home site is excavated and compacted using new fill. Wooden or metal forms are then placed around the perimeter of the house, forming the footprint of the house. Steel rebar is then placed throughout the area encompassing the footprint of the house, if reinforcement is needed. However, rebar is not always necessary. After the forms and any necessary reinforcement is in place, the appropriate amount of concrete is poured to form the building foundation. In some cases, the reinforcing steel or rebar extends above the slab for later tie-in to the walls of the house. Ties and anchor bolts are wet set in the concrete so that they are completely tied into the structure. A house can then be built on and attached to the finished building foundation.

Building foundations formed in such a way provide a very stable foundation which protects from damage even in rising waters, seismic events, and high winds. However, it is desirable to improve the efficiency of forming building foundations.

### SUMMARY

The present invention relates to a building foundation. A building foundation includes a molded structure being formed from a first substance and a second substance formed within the molded structure. The second substance displaces a predetermined volume of the first substance and is lighter than the first substance. The building foundation also includes a means for coupling the molded structure to a movable building in a factory. The building foundation is further adapted to be transported to a building site.

In another embodiment, the present invention relates to a method of moving a preformed building and foundation. The method includes the steps of forming a mold having at least one spacer material therein, pouring a first substance into the mold to form a molded structure, curing the molded structure, attaching the molded structure to at least one preformed building, moving the attached molded structure and the preformed building to a predetermined building site, and installing the attached molded structure and the preformed building on the predetermined building site.

In another embodiment, the present invention relates to another method of moving a building. This method includes the steps of forming a mold having at least one spacer material therein, pouring a first substance into the mold to form a molded structure, curing the molded structure, constructing at least one portion of a building on the molded structure in a factory, moving the attached molded structure and the building to a predetermined building site, installing the attached molded structure and the building on the predetermined building site.

Additional features and advantages are described herein, and will be apparent from, the following Detailed Description and the figures.

### BRIEF DESCRIPTION OF THE FIGURES

FIG. 1 is a top perspective view of a building foundation mold receiving concrete according to a first embodiment of the present invention.

FIG. 2 is a top perspective view of the mold of FIG. 1 with a cured building foundation removed from the building foundation mold.

FIG. 3 is a top perspective view of a finished and moveable building being attached to the cured building foundation of FIG. 2.

FIG. 4 is a top perspective view of another embodiment of a building foundation including tension cables.

FIG. 5 is a perspective view of the embodiment of FIG. 4 including a partially completed stick-built structure.

FIG. 6 is a perspective view of the embodiment of FIG. 4 including the completed stick-built structure.

FIG. 7 is a perspective view of the embodiment of FIG. 6 supported by a transport vehicle.

FIG. 8 is a perspective view of another embodiment of the present invention wherein the building foundation mold includes horizontal and vertical spacer elements.

FIG. 9 is a perspective view of the building foundation of FIG. 8 removed from the building foundation mold, with the horizontal and vertical spacer elements also removed.

FIG. 10 is a perspective view of another embodiment of the present invention wherein the building foundation includes protruding structural elements.

### DETAILED DESCRIPTION

FIGS. 1-3 illustrate a light weight and transportable building foundation and a method of forming such according to one embodiment of the present invention. The building foundation is formed using an appropriate material. Preferably, a building foundation mold is constructed into a desired building foundation shape that can receive the building foundation substance (a first substance). Spacer elements (a second substance) can be added to the building foundation mold. The spacer elements are placed into the mold in any suitable manner. The building foundation substance is cured to an appropriate level. The building foundation is removed from the mold when appropriate. A pre-built building is attached to the building foundation before or after the building foundation is moved and installed at a building site.

As shown in FIG. 1, the building foundation mold is an enclosed area formed from walls 2 and floor 4. The walls 2 and floor 4 are each a mold section that are combined to form a mold that is segmented. However, the walls 2 and floor 4 can be an integrated material, thus the mold can be formed from one mold section and not segmented. In another embodiment, the building foundation mold includes one or more mold sections. Mold sections can be of any suitable configuration (e.g., straight sections, right angle corners, T-intersections, cross intersections, curved sections, any suitable corner joint joining any suitable number of wall portions arranged at any suitable angle) and can have any suitable length or dimensions. However, a segmented mold is not required, and a mold can be built in a non-modular or even non-reusable manner.

To build a mold, a suitable mold section or sections are selected and arranged together. The mold can have any suitable shape or structure (e.g., a square, rectangle, circle, etc.), and preferably at least includes the perimeter of the eventual building that will rest upon the building foundation. However, the mold is not required to include the perimeter of the eventual building and can include some combination of the perimeter of the internal and/or external walls of the building or another portion of the building. Similarly, a building foundation mold can be constructed from multiple molds that are selected and arranged together. The molds can then be coupled in any desirable fashion. In one example, a square mold can be paired with one or more rectangle molds to form a desired building foundation; however, the selection and arrangement can be in any desirable manner including any mold shape.

During or after the mold construction, one or more spacer elements 6 are set within the mold. The spacer elements offset the volume available for the main building foundation substance. The spacer elements are pre-formed from a material that is preferably lighter in weight than the substance used to form the main building foundation or from a material that has a lower density; however, spacer elements 6 can be formed from any suitable material. Preferably, the spacer elements are made from a lightweight polymer (e.g., rigid foam or other suitable material) that can withstand fluid pressure that the first substance may exert on the spacer elements while in the mold. However, spacer elements can be formed from other polymers (e.g., plastics or other suitable polymers), steel, wood, gas, composites, or any other suitable alternative or combination thereof. Additionally, depending on the type of materials used for the spacer elements, the spacer elements can be solid or hollow.

The spacer elements can be cylindrical columns, or any suitable shape or structure (e.g., tubes, cubes, spheres, cones, box, cylinder, parallelpiped, prism, pyramid, regular pyramid, right cone, right cylinder, right prism, polyhedrons, ellipsoids, spheroids, etc.). In one embodiment, the spacer elements are rectangular columns. In another embodiment, the spacer elements can be formed from hexagons. However, any suitable polyhedron, shapes as listed above, combination of shapes, or structures can be used to form the spacer elements.

Preferably, as shown in FIG. 1, the spacer elements are vertically oriented or substantially vertically oriented and extend through or substantially through the entire building foundation. The spacer elements can also be horizontally or substantially horizontally oriented. Alternatively, the spacer elements can be in a combination of vertical and horizontal orientations or in another other suitable position or orientation. Additionally, the spacer elements may be embedded within the building foundation such that the spacer elements are not exposed or substantially exposed at any surface of the building foundation. The unexposed spacer elements can also be vertically or horizontally situated or situated in another suitable position or orientation.

Where the spacer elements extend beyond the building foundation in either the vertical or horizontal direction and remain within the building foundation, the spacer elements can be trimmed to be substantially flush with the building foundation, if desired. Alternatively, where the space elements extend beyond the building foundation in either the vertical or horizontal direction, the exposed spacer elements can be left intact and serve as a support or gripping extension when the building foundation is moved between different locations or for any other suitable purpose or for no purpose.

Preferably, the mold includes one or more spacer elements. The spacer elements reduce the total amount of the building foundation substance used to form the main building foundation. Preferably, the quantity of spacer elements is maximized to reduce the total weight of the building foundation. However, the number of spacer elements is determined by the strength to weight ratio needed for a given load characteristic. For example, if a building foundation needs to support a specific load requirement of 300 tons, the size, quantity, and spatial orientation of the spacer elements depends further on the known strength of the building foundation substance. Where the building foundation substance is unreinforced concrete, smaller and fewer spacer elements are likely used because unreinforced concrete generally requires more concrete and material continuity than reinforced concrete, to maintain an equivalent strength. However, larger and greater quantities of spacer elements can be used where the first substance is concrete reinforced with the compositions described above. Preferably, the volume of the spacer element is between 1% and 99% of the volume of the lightweight building foundation substance.

In one embodiment, hexagonal spacer elements are vertically oriented and used in such quantity that the spacer elements are attached to each other to form one or more honeycomb layers embedded within the concrete; however, a honeycomb layer can be formed with any other suitably shaped, vertically oriented spacer elements. Where the spacer elements form a honeycomb, the honeycomb can be formed from a metal, polymer, or any other suitable material or combination of materials. The honeycomb layer can serve to displace large areas of the first substance such that the honeycomb layer is sandwiched between layers of the building foundation substance.

In another embodiment, a mold is not used to form the building foundation. Substantially hollow spacer elements are used to form the one or more honeycomb layers and the one or more layers are formed into an appropriate building foundation; however, the one or more honeycombed layers can be filled with a building foundation substance to form a building foundation, if desired. Alternatively, the building foundation can be substantially formed from one or more honeycomb layers, without incorporating a building foundation substance. However, any suitable combination of honeycomb layers and building foundation substance can be used to form a building foundation with or without a mold.

In one embodiment, the spacer elements are permanently fixed into the mold. When the building foundation is cured and released from the mold, the spacer elements remain with the mold. When the spacer elements are left with the mold, the spacer elements can be removed from the mold at any later time if they need to be repaired, replaced, or exchanged for different spacer elements.

Alternatively, the spacer elements can be removable from mold. When the spacer elements are removable from the mold, the cured building foundation can be released from the mold and the spacer elements substantially simultaneously or in any order desired. In another embodiment with removable spacer elements, the spacer elements remain in the building foundation when the building foundation is released from the mold. In one such embodiment, the spacer elements are nondestructively released from the cured building foundation (i.e., the spacer elements are reusable). In another alternative embodiment, the spacer elements are destructively removed from the building foundation (i.e., not reusable because they are drilled out, melted away, or destroyed in any other suitable manner without harming the building foundation). In yet another embodiment, the spacer elements are permanently installed in the building foundation.

FIG. 1 also depicts a building foundation substance mixer 8 releasing the building foundation substance 10 into mold 12 to form the building foundation; however, the substance can be positioned in the mold in any suitable manner. Preferably, the building foundation substance is a concrete formed from a mixture of cement and a sand and/or gravel aggregate; however, the concrete can be any suitable mixture including, but not limited to, those having a lighter weight aggregate such as pumice, scoria, volcanic cinders, tuff, diatomite, heated/processed clay, heated/processed shale, heated/processed slate, heated/processed diatomaceous shale, heated/processed perlite, heated/processed obsidian, heated/processed vermiculite, or industrial cinders, polymers, Styrofoam, plastic or ceramic beads or nuggets, blast-furnace slag that has been specially cooled and/or mixtures including foaming agents such as aluminum powder (which produces gas while the concrete is still plastic) or other pocket forming materials. Alternatively the building foundation can be manufactured from cement or using any other suitable substance, in any other suitable manner.

The building foundation is allowed to substantially cure before it is removed from the building foundation mold; however, the building foundation can be removed from the building foundation mold at any other appropriate time. FIG. 2 illustrates a cured building foundation 14 in accordance with one embodiment. The building foundation mold 12 and building foundation 14 are separated from each other. The spacer elements 6 and building foundation mold 12 are preferably treated such that they can easily be separated from substantially cured building foundation 14; however, it may not be necessary to treat the spacer elements and/or the foundation.

Holes 16 are preferably continuous or substantially continuous from the top of building foundation 14 to the bottom of building foundation 14; however, holes 16 do not need to be continuous and can extend partially through or within the building foundation. Holes 16 reduce the amount of the main building foundation substance needed to form the building foundation.

FIG. 3 illustrates building foundation 14 used in accordance with one embodiment. The building foundation 14 is coupled to a substantially completed and movable building 18 within a factory. The building foundation 14 and movable building 18 are securely coupled together using any known coupling devices (e.g., bolting the building foundation 14 to the movable building 18). Once the building foundation 14 and movable building 18 are securely coupled, the completed structure is moved to the final building site for installation.

In one embodiment, a building foundation is manufactured and then transported in any suitable manner to a building site for placement. Preferably, the building foundation is manufactured within an enclosed facility; however, the building foundation can be manufactured outdoors or in any other suitable location. Further, the building foundation is preferably manufactured at a location which does not require transporting the building foundation via public roadways to the building site; however, the building foundation can be manufactured at a location for which transporting the building foundation to the house site via public roadways would be necessary or desirable. Further still, the building foundation can have any suitable dimensions, including, but not limited to: those which would provide a foundation for a house or other structure that is too large to transport over public roads due to legal, physical or any other limitation; those having length and width dimensions such that the smaller of the length and width dimensions is greater than 16 feet; and those which would support a multiple story structure. It should be noted that a building foundation can also be transported to a site (i.e., a structure site) for any suitable type of structure (e.g., a townhouse row, a commercial facility, an apartment complex, an agricultural building, etc.) and that house or home sites are a subset of structure sites.

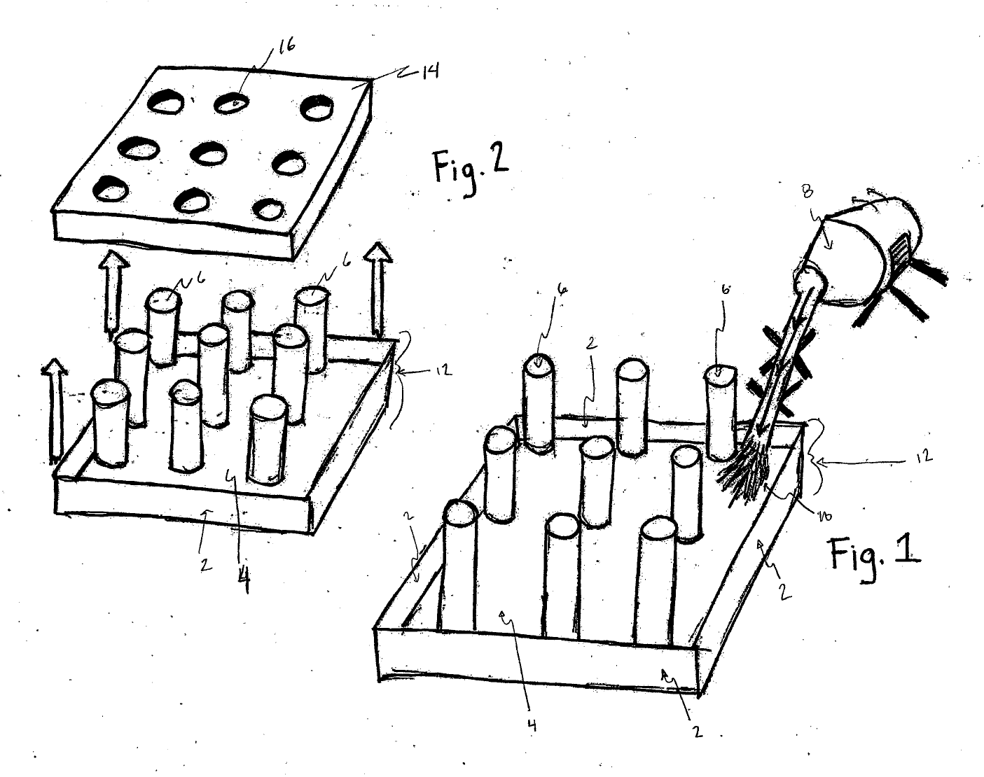

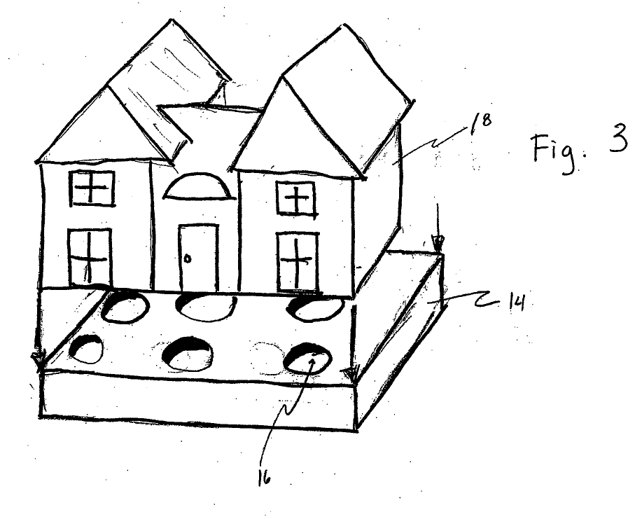

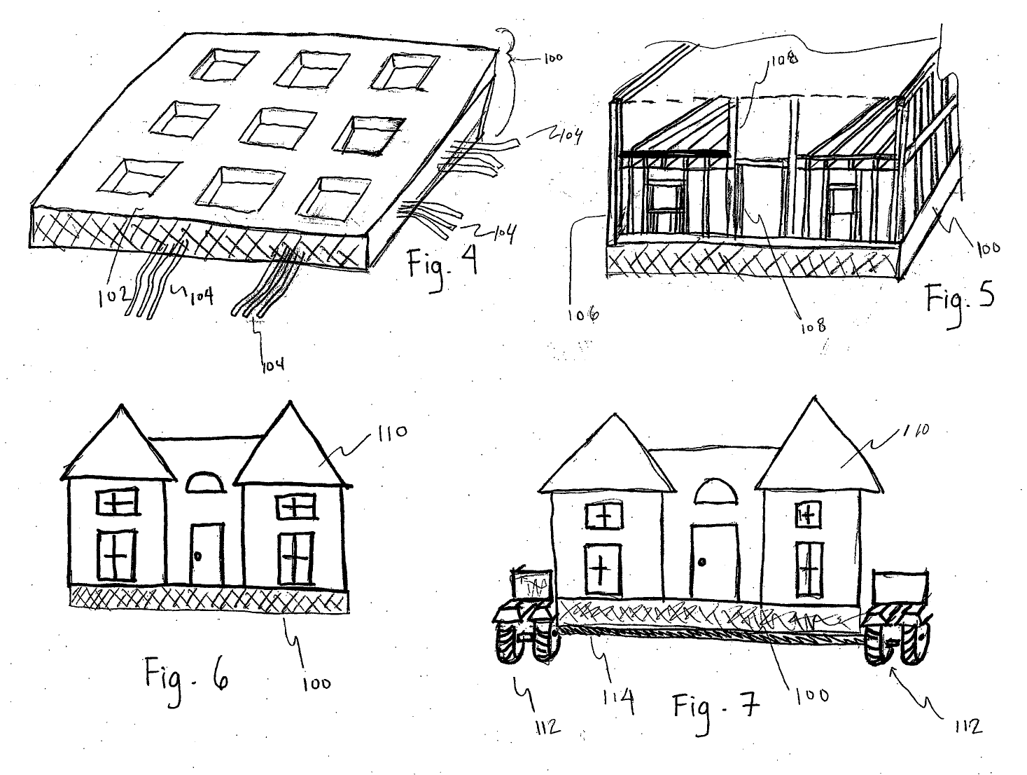

FIGS. 4 to 7 illustrate a building foundation and house built in a factory. The building foundation is formed from poured concrete at a factory in accordance with one embodiment.

As shown in FIG. 4, a mold is assembled from mold sections within a factory, in accordance with the methods described above. A plurality of spacer elements are placed within the mold in accordance with the methods described above.

Preferably, tension cables are also placed within the mold and are stressed after the concrete cures to provide increased tensile strength. However, tension cables are not required and the building foundation can be unreinforced or reinforced with any suitable component such as rebar or a wire mesh or any combination of suitable reinforcement components. The rebar or cable used within the mold are often deformed or threaded steel bars. However, fiber-reinforced polymer bars or other suitable material combinations can be used in place of steel rebar or cable. Additionally, the concrete can be further reinforced using fibers of various materials. The concrete can be mixed with fibers made from steel, glass, synthetic (nylon, polyester, and polypropylene), natural fibers, or any other suitable fiber. Using appropriate quantities of fibers, the concrete can achieve increased durability from increased resistance to: plastic and drying shrinkage, cracking, reduced crack widths, enhanced absorption, and impact resistance.

Concrete or another suitable substance is then poured into the mold and allowed to substantially cure. The building foundation is then released from the mold and the tension cables are tightened. The spacer elements remain with the mold. FIG. 4 illustrates a cured and released building foundation 100 with spacer element holes 102 and tension cables 104.

FIG. 5 illustrates the building foundation 100 with a partially formed, stick-built house 106. The released building foundation 100 is preferably placed at a building station within the factory; however, as with the embodiments described above, the foundation 100 does not necessarily need to be positioned within a factory and can be positioned or placed in any suitable location. Materials to stick build the house are brought to the building foundation 100 or vice versa. The house is built from the building foundation upwards using wood studs 108 in a conventional stick-built manner or any other suitable manner. Additionally, any suitable building material can be used to frame the house (e.g., metal, composites, concrete).

The frame of partially stick-built house 106 depicts a first and second floor with windows and a door. It should be appreciated that any home or building design can be used. The partially stick built house 106 is bolted to the building foundation using one or more bolts and/or brackets as is necessary to secure the building foundation and completed house together for transport from the factory or any other suitable method. FIG. 6 illustrates the building foundation 100 coupled to the completed home 110 within the factory.

FIG. 7 illustrates a complete home 110 connected to building foundation 100 and prepared for transport. One or more transport vehicles 112 are positioned near completed home or substantially completed home 110 and building foundation 100 in the factory or other suitable location. The completed home 110 and building foundation 100 are lifted by crane or any other suitable lifting/hoisting device on to transport vehicles 112. The completed home 110 and building foundation 100 are supported on the transport vehicles 112 by platform 114. Platform 114 comprises one or more beams or an integrated and continuous surface capable of supporting the combined load of the completed home 110 and building foundation 100. The transport vehicles 112 move the completed home 110 and building foundation 100 to the home site for installation.

The transport vehicle or vehicles can be any suitable vehicle or combination of vehicles. For example, the transport vehicle can be a flat bed, a frame system or a plurality of dollies capable of coupling or supporting the building in any suitable manner. Additionally, the vehicle can be a plurality of vehicles that couple to the building or support the building, as described in the above mentioned co-pending U.S. patent application Ser. Nos. 11/431,196; 11/559,229; and 11/620,103. As discussed therein, each separable portion of such a transport can be positioned adjacent or along side the building and couple thereto. Thus, lifting the building and eliminating the need for a crane or other lifting device. It is noted however, that any lifting device or means can be used to position the building on to this type of transport device or any other type of transport device.

It should be appreciated that in other embodiments, the order of some or all of the above steps (e.g., the curing, the tightening and the releasing) can be performed in a different order.

In another embodiment, after the building foundation is transported to the building site, a building is built or placed on top of the building foundation. Preferably, the building is secured to the building foundation in any suitable manner, including those described above for a site-built or attached house; however, the building is not required to be secured to the building foundation. In one embodiment, the building foundation is placed or formed on skates which are operable to transport the building foundation within a structure manufacturing facility or site; however, the building foundation can be transported within the facility or site in any suitable manner (e.g., rails, cranes, vehicles, air cushion, dollies, reduced friction surfaces, water, etc.) or remain stationary until being transported to the building site. Alternatively, a building foundation can be manufactured at one facility or site and transported to one or more other facilities or sites at which a building that is at least partly built, is placed upon the building foundation before the building foundation is transported to and placed at the building site.

In an alternative embodiment, the building foundation is moved on the skates from station to station, and at each station one or more portions of the house or structure is built on or added to the building foundation/house structure. However, the building foundation is not required to be moved from station to station. The building foundation can remain substantially in one position while a house or other structure is placed or built upon the building foundation. For example, a full-sized house (e.g., a non-roadable house, a mini-mansion, houses larger than mobile homes, etc.) can be built or assembled within the facility or brought to the facility and attached to the building foundation. Alternatively, a full-sized house can be built in any suitable manner (e.g., stick building, panelized building, modular building) onto the building foundation. Further it should be noted that alternatively, a smaller dwelling such as a mobile home can be placed or built upon the building foundation. It should also be noted that structures other than houses (including but not limited to townhouse rows, apartment buildings, commercial structures, agricultural buildings or any other suitable structure) can be placed or build upon the building foundation.

In one embodiment, after the building foundation and house are coupled, the building foundation and house are transported to the house site in any suitable manner, including, but not limited to, those described above for transporting the building foundation. Alternatively, transporting the building foundation and house can include coupling a moving apparatus (e.g., one or more vehicles, a crane, etc.) to a structure of the house or building foundation, a protrusion from the house or building foundation, an opening into the house or building foundation, by any of the mechanisms described in co-pending U.S. patent application Ser. Nos. 11/431,196 and 11/559,229, the entire contents of both of which are incorporated herein by reference, or any other suitable mechanism for grasping the house as well as or instead of the building foundation.

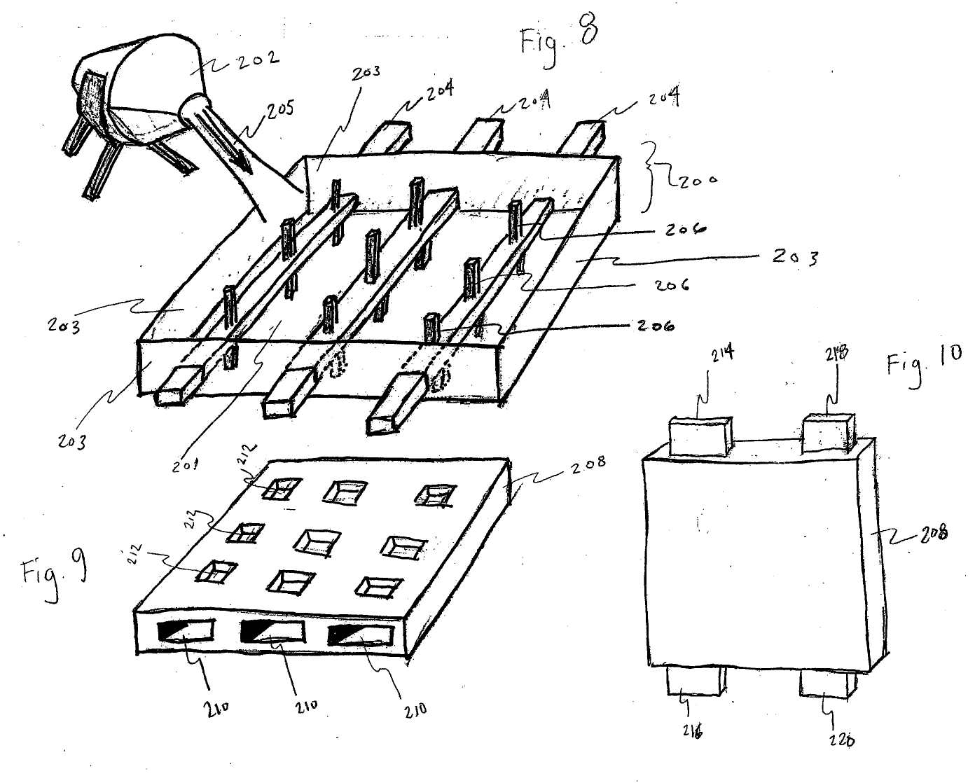

FIGS. 8-10 illustrate a building foundation or wall that can be formed with horizontal and vertical spacer elements, or either horizontal or vertical spacer elements; however, it is noted that the spacer elements do not necessarily need to be vertical and/or horizontal and can extend at any suitable angle.

FIG. 8 illustrates a building foundation mold 200 that forms an enclosed area using walls 203 and floor 201. Walls 203 can have openings to allow horizontal spacer elements 204 to pass beyond the perimeter of mold 200. One or more horizontal spacer elements 204 can be set within mold 200 and extend beyond two walls 203 of mold 200. One or more vertical spacer elements 206 can also be set within the mold 200 and can be flush with the top and bottom of mold 200. The vertical spacer elements 206 can be continuous structures that are perpendicular to and placed through horizontal spacer element 204. A building foundation substance mixer 202 provides mold 200 with a building foundation substance 205 to form the building foundation. The building foundation is substantially cured after the building foundation substance 205 is placed in the mold 200.

Alternatively, the horizontal spacer elements can remain confined within the perimeter of mold 200, or any other suitable arrangement. The horizontal spacer elements can be formed in any manner as described above in connection with the spacer elements. Similarly, the horizontal spacer elements may remain with the building foundation or be removed from the building foundation as described above (e.g., destructively or non-destructively). Vertical spacer elements 206 can alternatively extend beyond the top and bottom of mold 200. Alternatively, vertical spacer elements 206 can be shorter structures that are placed on the top and bottom, or either the top or the bottom of the horizontal spacer elements 204, but are not continuous. In yet another embodiment, the vertical spacer elements 206 do not intersect or do not come into contact with horizontal spacer element 204 and are placed in alternative or alternating locations of mold 200. The vertical spacer elements 206 can be formed in any manner as described above in connection with the spacer elements.

FIG. 9 illustrates a cured building foundation 208 in accordance with one embodiment. The building foundation 208 is removed from the building foundation mold 200. Horizontal spacer elements 204 and vertical spacer elements 206 are also removed from building foundation 208. The horizontal holes 210 in building foundation 208 depict the areas previously occupied by horizontal spacers 204. The vertical holes 212 in building foundation 208 depict the areas previously occupied by vertical spacers 206. Beams or pegs can be inserted into any of the holes 210 or 212 (or in any other suitable location) to facilitate moving building foundation 208 from one location to another.

FIG. 10 illustrates a cured building foundation 208 in accordance with one embodiment. The building foundation 208 is removed from a building foundation mold. This building foundation 208 was formed without any vertical spacer elements. However, it should be appreciated that vertical spacer elements can be formed within building foundation 208 as described above. Horizontal spacer elements have been removed from building foundation 208 (either destructively or non-destructively). Protruding structures 214, 216, 218, and 220 depict beams or pegs that have been inserted into the areas within building foundation 208 that were previously occupied by the horizontal spacer elements. Protruding structures 214, 216 and 218, 220 can be one continuous structure. Alternatively, protruding structures 214, 216 and 218, 220 can be shorter structures that are not continuous. Protruding structures 214, 216, 218, and 220 can also be formed from the horizontal spacer elements.

Additionally, building foundation 208 can function as one section of a stem wall for a building. Stem walls tie the building to the ground and can support the exterior and interior load and non-load bearing walls. In one embodiment, a mold is formed as discussed above. The mold can be designated to form one or more stem wall sections. Once the stem walls are substantially formed, one or more stem walls sections can be coupled together in any suitable fashion to form at least a portion of the stem wall or the entire stem wall. The stem wall sections can be coupled to a building foundation in any suitable fashion. In one embodiment, the one or more stem wall sections can be coupled to the building foundation in a factory. Alternatively, the stem wall sections can be coupled to the building foundation at the building site. In an alternative embodiment, one or more stem wall sections can be used to form a perimeter around the entire building foundation. The one or more stem wall sections can be coupled to the building foundation in any suitable manner. In another embodiment, a single mold can be formed to incorporate one or more stem wall sections and a building foundation. The resultant mold creates one or more stem wall sections that are integral with the building foundation. In all of the above embodiments, the stem wall can be formed in a factory or formed on a building site. The stem wall can also be coupled to a building foundation in a factory or at a building site.

In one alternative embodiment, the building foundation is formed with one or more vertical and horizontal openings. The openings are created when the spacer elements are placed in the mold and then removed from the cured building foundation. Beams or pegs can be inserted through the horizontal openings to facilitate transportation of the building foundation to the house site. Preferably, the horizontal openings are configured such that a beam can extend through the building foundation; however, such a configuration is not required. The length of the horizontal openings only need to be sufficiently long enough to support the load of the building foundation and an attached building. In an alternative embodiment, instead of or in addition to the horizontal openings, one or more protruding members are formed extending beyond one or more exterior ends of the building foundation. The protruding member can be part of the mold and poured similar to the rest of the building foundation. Alternatively, a beam (e.g., a steel I beam) is positioned within the mold such that when the building foundation is poured, a portion of the beam extends beyond the exterior ends of the building foundation.

In another alternative embodiment, exterior face attachment points (e.g., exterior brackets, protrusions or any other suitable graspable structure) are attached to one or more exterior ends of the building foundation. The exterior face attachment points can be attached after concrete is poured into the mold or can be positioned within the mold such that the exterior face attachment points are formed as a continuous part of the building foundation. The exterior face attachment point can include an embedded steel plate to which an external bracket can be mounted or attached (e.g., by bolting, welding or any other suitable attachment mechanism). The external bracket can also have any suitable configuration and is preferably operable with one or more other attachment points to enable one or more transportation vehicles to grasp and/or lift the building foundation.

In one embodiment, after the building foundation is formed, it is transported to and positioned at the house site. Preferably, one or more ground transportation devices are coupled to the building foundation by gripping the beams or other objects (e.g., cables, brackets, etc.) inserted through the horizontal holes; however, the devices can be coupled to the building foundation in any other suitable manner, including but not limited to by inserting pegs of the devices into the horizontal holes or by gripping one or more protruding members or exterior attachment points described above. It should be noted that the building foundation is not required to be transported by a ground vehicle and that the building foundation can be transported by an air vehicle (e.g., a helicopter), a water vehicle (e.g., a barge) or any other suitable vehicle (e.g., a crane, an amphibious craft, etc.).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A building foundation, comprising:
a molded structure being formed from a first substance;
a second substance formed within said molded structure, displacing a predetermined volume of said first substance and being lighter than said first substance; and
a means for coupling said molded structure to a movable building in a factory;
wherein said building foundation is adapted to be transported to a building site.

2. The building foundation according to claim 1, wherein said molded structure is formed from a substantially homogeneous substance.

3. The building foundation according to claim 2, wherein said substantially homogeneous substance is formed from at least one of: concrete, concrete composite, steel, or polymer.

4. The building foundation according to claim 1, wherein said second substance is selected from at least one of: a polymer, gas, metal, or wood.

5. The building foundation according to claim 1, wherein said predetermined volume is between about 1% and about 50% of the volume of said first substance.

6. The building foundation according to claim 1, wherein said second substance forms a second structure selected from the group consisting of a cylinder, sphere, cone, or polyhedron.

7. The building foundation according to claim 6, wherein said second structure has a longitudinal axis and at least one surface, wherein said longitudinal axis extends along the horizontal or vertical plane of said molded structure.

8. The building foundation according to claim 7, wherein said second structure extends from a first end of said molded structure to a second end of said molded structure.

9. The building foundation according to claim 1, wherein said second substance defines a substantially hollow structure.

10. The building foundation according to claim 9, further comprising a coupling means for coupling said building foundation to a transport vehicle.

11. The building foundation according to claim 1, wherein said second substance defines a substantially solid structure.

12. A method of moving a preformed building and foundation comprising the steps of:
forming a mold having at least one spacer material therein;
pouring a first substance into said mold to form a molded structure;
curing said molded structure;
attaching said molded structure to at least one preformed building;
moving said attached molded structure and said preformed building to a predetermined building site;
installing said attached molded structure and said preformed building on said predetermined building site.

13. The method according to claim 12, wherein said first substance is formed from at least one of: concrete, concrete composite, steel, or polymer.

14. The method according to claim 12, wherein said spacer material is between about 1% and about 50% of the volume of said first substance.

15. The method according to claim 12, wherein said spacer material includes at least one of the following: polymer, gas, metal, or wood.

16. The method according to claim 12, wherein said spacer material is formed into at least one predetermined structure.

17. The method according to claim 16, wherein said spacer material is substantially hollow.

18. The method of claim 17, further comprising the step of attaching said molded structure and preformed building to a transport vehicle using an attachment means.

19. The method according to claim 16, wherein said spacer material is substantially solid.

20. A method of moving a building comprising the steps of:
forming a mold having at least one spacer material therein;
pouring a first substance into said mold to form a molded structure;
curing said molded structure;
constructing at least one portion of a building on said molded structure in a factory;
moving said attached molded structure and said building to a predetermined building site;
installing said attached molded structure and said building on said predetermined building site.
